(19) United States
(12) Patent Application Publication
(10) Pub. No.: US 2021/0276837 A1
(43) Pub. Date: Sep. 9, 2021

(54) SWIVEL HOOK ASSEMBLY FOR CRANE CABLE

(71) Applicant: Anders RAGNARSSON, Chester, NH (US)

(72) Inventor: Anders RAGNARSSON, Chester, NH (US)

(21) Appl. No.: 16/808,760

(22) Filed: Mar. 4, 2020

(51) Int. Cl. B66C 1/34

(52) U.S. Cl. CPC B66C 1/34

(57) ABSTRACT

A swivel hook assembly which comprises a hook unit that supports a hook which facilitates suspending a desire piece of equipment from the swivel hook assembly. The hook unit is engageable with a free end of a wire cable that controls vertical and horizontal movement of the hook unit. A hook coupling has an upper end which engages with a jib and a second end for engaging with the hook unit. When the hook unit is spaced away and disengaged from the hook coupling, the hook unit is rotatable relative to the hook coupling. However, when the hook unit is moved, by the wire cable, into engagement with the hook coupling, relative rotation between the hook unit and the hook coupling is prevented and more precise control over the suspended desire piece of equipment is achieved by the operator.

### FIELD OF THE INVENTION

The present invention relates to a swivel hook assembly which is utilized in combination with a wire cable and the swivel hook assembly has a first disengaged operative position and second engaged operative position. When the swivel hook assembly is in the first disengaged operative position, the hook unit is freely rotatable with respect to the hook coupling while, when the swivel hook assembly is in the second engaged operative position, rotation of the hook unit, relative to the hook coupling, is prevented.

### BACKGROUND OF THE INVENTION

Crane and wire cables are generally well known in the art and are utilized for a variety of different applications. A conventional wire cable is normally dispensed from a conventional spool and conveyed along the length of a mechanical arm or boom which extends from a base of heavy equipment, motorized forestry equipment, or some other similar heavy duty piece of equipment or vehicle. The free end of the wire cable supports a conventional hook for lifting and conveying a desired load, material(s), item(s), etc.

In addition, many of the known prior art suspended pieces of equipment are somewhat difficult for an operator to maneuver.

### SUMMARY OF THE INVENTION

Wherefore, it is an object of the present invention to overcome the above mentioned shortcomings and drawbacks associated with the prior art.

An object of the present disclosure is to provide a swivel hook assembly which is utilized in combination with a wire cable and the swivel hook assembly has a first disengaged operation position in which the hook unit is freely rotatable with respect to the hook coupling and a second engaged operating position in which the hook unit is retracted toward and engaged with the hook coupling so that rotation of the hook unit, relative to the hook coupling, is thereby prevented.

A further object of the present disclosure is to provide the swivel hook assembly that can be easily engage and disengage by merely controlling the length or amount of the dispensed wire cable.

The present invention also relates to a swivel hook assembly comprising a hook unit supporting a hook which facilitates suspending a desire piece of equipment from the swivel hook assembly, and the hook unit being engageable with a free end of a wire cable which controls at least vertical movement of the hook unit; and a hook coupling having an upper end for engagement with a jib and a second end for engaging with the hook unit so that, when the hook unit is moved by the wire cable into engagement with the hook coupling, relative rotation between the hook unit and the hook coupling is prevented while, when the hook unit is spaced away and disengaged from the hook coupling, relative rotation between the hook unit and the hook coupling is permitted.

The present invention further relates to a method of suspending a desire piece of equipment from a swivel hook assembly, the method comprising supporting a hook, via a hook unit, which facilitates suspending the desire piece of equipment from the swivel hook assembly; engaging the hook unit with a free end of a wire cable which controls at least vertical movement of the hook unit; and providing a hook coupling having an upper end for engagement with a jib and a second end for engaging with the hook unit such that when the hook unit is moved, by the wire cable, into engagement with the hook coupling relative rotation, between the hook unit and the hook coupling, is prevented but, when the hook unit is spaced away and disengaged from the hook coupling, relative rotation between the hook unit and the hook coupling is permitted.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic right side view of the swivel hook assembly according to the disclosure;

FIG. 2 is a diagrammatic front elevation view of the swivel hook assembly of FIG. 1;

FIG. 3 is a diagrammatic partial cross sectional view of the swivel hook assembly of FIG. 1, along section line 3-3, in its extended disengaged position, which shows the mating alignment features for aligning the male housing of the hook unit with the hook coupling;

FIG. 4 is a diagrammatic right side view of the swivel hook assembly, similar to FIG. 1, showing the swivel hook assembly in its retracted and engaged operation position which prevents relative rotation, between the hook unit and the hook coupling, while still permitting the swivel hook assembly to pivot, in a plane, back and forth relative to the jib;

FIG. 5 is a diagrammatic right side view showing a second embodiment of the swivel hook assembly having alternative mating alignment features;

FIG. 6 is a diagrammatic left side view of a further embodiment of the swivel hook assembly according to the disclosure;

FIG. 6A is a diagrammatic top view of the hook housing, of the hook coupling, along section line 6A-6A of FIG. 6;

FIG. 6B is a diagrammatic view of the hook housing along section line 6B-6B or FIG. 6A;

FIG. 7 is a diagrammatic front elevation view of the swivel hook assembly of FIG. 6; and

FIG. 8 is a diagrammatic side elevational view of only the hook coupling, shown affixed to the crane or jib.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description of the disclosure, which should be read in conjunction with the appended drawings. It is to be appreciated that the following detailed description of the embodiments is by way of example only and is not meant to limit, in any way, the scope or breath of the present invention.

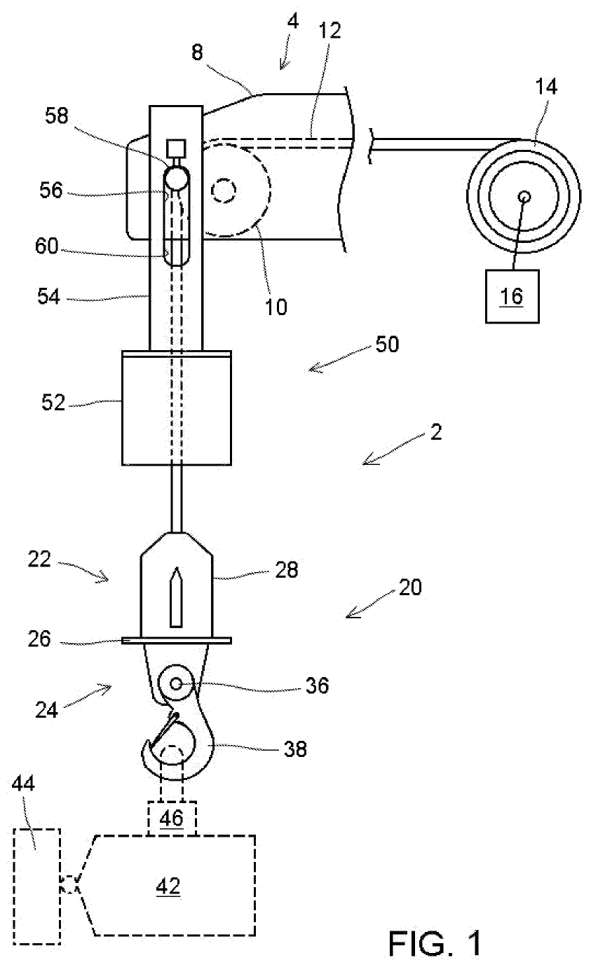

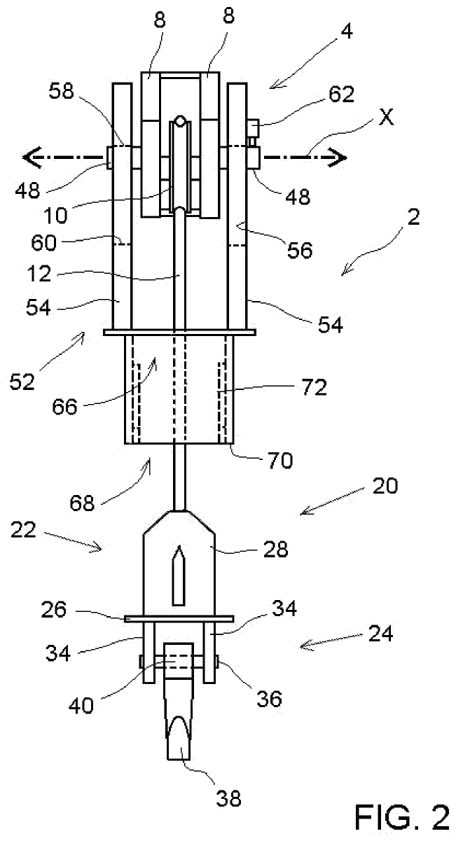

Turning first to FIGS. 1-3, a detail description concerning the various components of the present invention will now be briefly discussed. As can be seen in this embodiment, the present invention relates to a swivel hook assembly 2 which is attached to a hydraulically actuated arm or jib 4 that is fixedly connected to an upper most section of a crane, or some other similar piece of equipment (not shown in detail). As best shown in FIG. 2, the jib 4 comprises a pair of spaced apart members or plates 8 which support and accommodate a rotatable final pulley 10 therebetween—typically the crane, mechanical arm, boom or jib 4 will support a plurality of sequentially arranged pulleys (not shown in detail) which support the wire cable 12. It is to be appreciated that since the various components of a conventional crane and jib are well known in the art, a further discussion concerning the same is not provided. It is also appreciated that there are a number of different types of heavy equipment bases, motorized forestry equipment, and other similar heavy duty equipment or vehicles that have a variety of mechanical arms, booms or jibs, and the following description will generically refer to all such heavy pieces of equipment and mechanical arms as simply a crane or jib 4.

As is typical in the art, a first end of the conventional wire cable 12 is connected to a rotatable spool 14 which is located at a base 16 of the crane or jib 4 (only diagrammatically shown). When the spool 14 is rotated in a first rotational direction by a motor (not shown), e.g., a gas, a diesel, an electric, or a hydraulic motor for example, the spool 14 feeds out an additional amount of the wire cable 12 so as to increase the overall length of the dispensed wire cable 12. Alternatively, when the spool 14 is rotated in an opposite second rotational direction, the spool 14 gradually reels in a portion of the dispensed wire cable 12 so as to decrease the overall length of the dispensed wire cable 12. As the feeding out and the reeling in of the wire cable 12 from the spool 14 is conventional and well known in the art, a further detail discussion concerning the same is not provided.

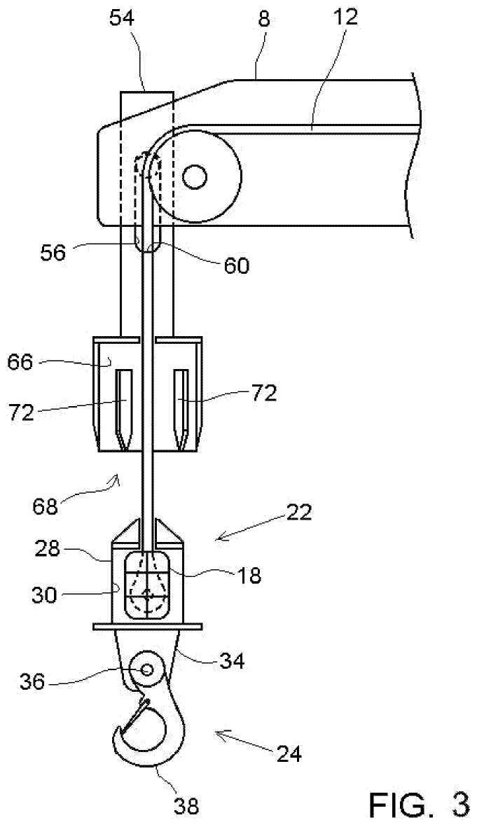

The second free end 16 of the wire cable 12 is supported by one or more conventional pulleys before finally wrapping partially around the final pulley 10 of the jib 4 and then extending substantially vertically downward. The second free end of the wire cable 12 eventually terminates as an enlarged cylindrical head 18 (see FIG. 3). The second free end 16 of the wire cable 12 is securely and permanently embedded within the enlarged cylindrical head 18, which is typically manufactured from a metal for example, so as to be formed integral therewith.

A hook unit 20, discussed below in further detail, is supported by and forms the lower portion of the swivel hook assembly 2. The hook unit 20 generally comprises an upper end 22 which is formed integrally with a lower end 24 and a circular ring or disc 26 is located therebetween and formed integrally as part of the hook unit 20.

An exterior surface of the upper end 24 of the hook unit 20 generally comprises a male housing 28. An interior of the male housing 28 is sized and shaped so as to defining a cylindrically shaped internal compartment 30 which permanently receives and closely accommodates the enlarged cylindrical head 18 while still, at the same time, permits rotation of the enlarged cylindrical head 18 relative to the male housing 28. As a result of such arrangement, the hook unit 20 is permitted to rotate 360 degrees relative to the enlarged cylindrical head 18 and the second end of the wire cable 12, in either rotational direction, during operation. To assist with such relative rotation, the internal compartment 30 may be packed with or contain grease or some other lubricant for example (not shown in detail), so as to minimize the friction which is generated during such relative movement between those components.

The lower end 24 of the hook unit 20 comprises a pair of spaced apart support members 34 which has a hook pin 36 extending therebetween. Each opposed end of the hook pin 36 is permanently secured to a respective one of the pair of spaced apart support members 34. An upper region of a conventional hook 38 is provided with a through bore 40 which extends completely through the upper region. The hook pin 36 extends through the through bore 40 and thereby pivotally supports the hook 38 to the remainder of the hook unit 20. As a result of such arrangement, the hook 38 is capable of pivoting or swinging about the hook pin 36.

During use of the swivel hook assembly 2, a desired suspended piece of equipment 42 (only diagrammatically shown), e.g., a self-powered mulcher, a self powered grappler, etc., can be suspended from the hook 38. Thereafter, an operator of the crane or jib 4 can control the amount of wire cable 12 dispensed by the spool 14 of the crane or jib 4 in order to lower, raise, position or reposition the desired piece of equipment 42, suspended by the hook 38, at a desired location relative to a desired object 44 (only diagrammatically shown), e.g., a tree, in order to perform a desired operation, e.g., assist with removing a desired section or portion of a tree or a trunk, removing a desired limb or branch, etc.

It is to be appreciated that an upper most portion of the desired suspended piece of equipment 42 may be equipped with a hydraulic rotator 46 (only diagrammatically shown) which couples the desired suspended piece of equipment 42 to the hook 38 of the swivel hook assembly 2. As is well known in the art, the hydraulic rotator 46 is designed to assist the operator with rotating or “steer” of the desired suspended piece of equipment 42, relative to the swivel hook assembly 2 and the desired object 44, e.g., a section or portion of a tree or a trunk, a desired limb or branch, etc., into a desired operative position to perform the desired function. As the installation and operation of such a hydraulic rotator 46 is conventional and well known in the art, a further description concerning the same is not provided.

A pair of axially aligned pins 48 (as best shown in FIG. 2) are permanently secured to and extend outwardly away from and normal to the exterior surface of pair of plates 8 of the jib 4. The pair of axially aligned pins 48 together form a pivot axis X and a support for the swivel hook assembly 2, the purpose of which will become apparent from the following description. The pair of axially aligned pins 48 also prevent a hook coupling 50 from twisting or rotating relative to the jib 4. An upper end of the hook coupling 50 of the swivel hook assembly 2 has a pair of spaced apart coupling arms 54 which are spaced apart from one another by a distance slightly greater than the width of the jib 4, i.e., the spacing between the pair of spaced apart coupling arms 54 is slightly greater, e.g., a few inches or so, than the spacing between the outwardly facing surfaces of the two plates 8 of jib 4, as best shown in FIG. 2.

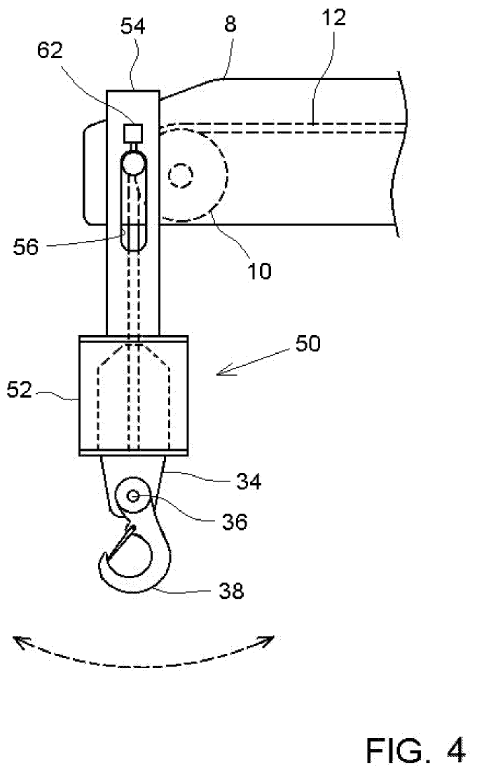

Each one of the coupling arms 54 has an elongate slot 56 formed therein. Each respective slot 56 is sized and shaped so as to receive and closely accommodate, with a small amount of play, a respective one of the axially aligned pins 48 therein. As normally shown, each first end of the elongate slots 56 is in engagement with a respective one of the axially aligned pins 48 so that the hook coupling 50 normally can rock or pivot back and forth about the pivot axis defined by the axially aligned pins 48, during operation of the swivel hook assembly 2. As a result of such arrangement, the hook coupling 50 is generally hung by the axially aligned pins 48 and is able to rock back and forth relative thereto in a plane, as shown by the double arrow in FIG. 4.

As will be discussed below in further detail, the pair of coupling arms 54 are able to move relative to the respective axially aligned pins 48, from their normally engaged position with the first end 58 of the respective elongate slots 56, as shown in FIGS. 1-3, toward an opposite second end 60 of the respective elongate slots 56. A limit switch 62, or some other conventional sensor, device or mechanism, is located adjacent the first end 58 of at least one of the elongate slots 56 to detect that a respective one of the axially aligned pins 48 is in abutting engagement with that first end 58 of the elongate slot 56. In the event that limit switch 62 detects that the first end 58 of one of the respective elongate slots 56 commences moving away from the respective axially aligned pin 48, i.e., the second end 60 of the elongate slot 56 moves toward the respective axially aligned pin 48, the limit switch 62 then transmits a signal or alarm to a receiver (not shown), associated with motor or the spool 14 (or possibly sends a signal to the operator), which automatically discontinues reeling in of any additional wire cable 12 by the spool 14 and thereby prevents damage from occurring to the swivel hook assembly 2 or the crane or jib 4. Following activation of the limit switch 62, the spool 14 may be activated (either automatically or by the operator) to dispense a small amount of the wire cable 12 so as to lower the swivel hook assembly 2 a small distance and again bring the axially aligned pins 48 into abutting engagement with the respective first ends 58 of the elongate slots 56 of the coupling arms 54 while still retaining the hook unit 20 in engagement with the hook coupling 50.

A lower most section of the hook coupling 50 comprises a hook housing 52 which defines a hook unit recess or aperture 66 and this hook unit recess or aperture 66 has an opening 68 which faces toward the hook unit 20. The hook unit recess or aperture 66 is sized and shaped to closely and intimately receive and accommodate the exterior surface of the male housing 28 of the hook unit 20, once the overall length of the dispensed wire cable 12 is gradually shortened and reeled onto the spool 14, as will be discussed below in further detail. The lower most portion of the hook unit recess or aperture 66 terminates at as a flat annular rim 70 and this flat annular rim 70 is sized, shaped and located to engage with a mating annular surface of the circular ring or disc 26 of the hook unit 20 and prevent further insertion of the male housing 28 into the hook unit recess or aperture 66. Once these two annular surfaces 26, 70 engagement with one another, the friction resulting therefrom also further assists with preventing relative rotation of the hook unit 20 with respect to the hook coupling 50 and the jib 4.

An inwardly facing surface of the hook unit recess or aperture 66 is typically provided with one or more alignment features 72, e.g., projections, indentations, ribs, grooves, slots, channels, rails, recesses, etc., which are located so as to engage with one or more mating alignment features 74, e.g., mating projections, indentations, ribs, grooves, slots, channels, rails, recesses, etc., carried by the male housing 28 of the hook unit 20. Accordingly, as the male housing 28 of the hook unit 20 is pulled or drawn into the hook unit recess or aperture 66 of the hook coupling 50, by the spool 14 shortening the overall length of the dispense wire cable 12, the mating alignment features 72, 74 of the hook unit 20 and the hook coupling 50 eventually engage with one another. To assist with proper and non-interfering alignment of the alignment features 74 of the male housing 28 with the mating alignment features 72 of the hook unit recess or aperture 66, the leading ends of one, or both of, the mating alignment features may be pointed, rounded or chamfered, or have some other conventional guiding and/or centering feature (not shown in detail).

Once the male housing 28 is sufficiently received by the hook coupling 50, the engagement between the mating alignment features 72, 74 function so as to prevent any further relative rotation or spinning of the hook unit 20 relative to the hook coupling 50. As noted above, the hook coupling 50 is mounted to the jib 4 so as to prevent any rotation of the hook coupling 50, and now the hook unit 20, relative to the jib 4. As such, when the male housing 28 is received within the hook coupling 50, such engagement prevents any relative rotation therebetween and assists the jib 4 with more precisely controlling and/or maneuvering of the suspended piece of equipment 42 relative to a desired object 44, e.g., a section or portion of a tree or a trunk, a desired limb or branch, etc.

Once the male housing 28 is fully seated within the hook coupling 50, any further shortening of the overall length of the dispensed wire cable 12, by the spool 14, will cause the enlarged cylindrical head 18 to pull and draw both the male housing 28 and the hook coupling 50 upwardly toward the final pulley 10 supported by the jib 4. As this occurs, the coupling arms 54 commence moving generally vertically upward, with respect to the axially aligned pins 48, so that the first ends 58 of the elongate slots 56 commence moving away from the respective axially aligned pins 48 and the second ends 60 of the elongate slots 56 commence moving toward the respective axially aligned pins 48. As soon as this occurs, the limit switch 62 detects such movement and sends a signal and/or sounds an alarm designed to prevent or minimize further reeling in or shortening of the dispensed length of the wire cable 12, by the spool 14, and thereby to prevent any damage from occurring to the swivel hook assembly 2 or the jib 4.

Once the limit switch 62 is activated, typically either the spool 14 will immediately discontinue rotation or the operator will actuate the spool 14 to discontinue operation thereof and possibly reverse the direction of the spool 14 so as to the feed out a small amount of additional wire cable 12, e.g., a 2-12 inches or so, so that the first ends 58 of the elongate slot 56 are again moved into engagement with the axially aligned pins 48 and the limit switch 62 thereafter detects such engagement.

It is to be appreciated that the swivel hook assembly 2 generally has two separate and distinct operative positions. The first disengaged operative position is when the male housing 28 is sufficiently spaced away from the hook coupling 50 so that none of the mating alignment features 72, 74 are in engagement with one another. In this disengaged operating position, the hook unit 20 is freely rotatable with respect to the hook coupling 50 and can be raised or lowered by the operator, as necessary or required, to manipulate the suspended piece of equipment 42 into a desired position and achieve a desired operating function of the suspended piece of equipment 42, e.g., chip a desired limb, branch, tree, trunk, cut off desired limbs or branches, cut of a desired section of a tree or a trunk, etc.

The swivel hook assembly 2 also has a second engaged operating position where the male housing 28 is sufficiently received within the hook unit recess or aperture 66 of the hook coupling 50 such that the mating alignment features 72, 74 of the male housing 28 and the hook unit recess or aperture 66 are in engagement with one another and prevent any relative rotation of the hook unit 20 relative to the jib 4.

As diagrammatically shown, the jib 4 generally provides additional reach over a desired structure, such as a building or structure, a power line, around an object, etc.

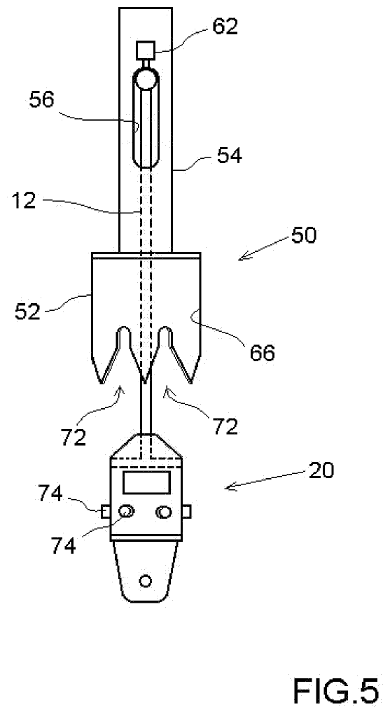

It is to be appreciated that a variety of other techniques for coupling the hook unit 20 to the hook coupling 50 to prevent any relative rotation from occurring therebetween, as well as decoupling the hook unit 20 from the hook coupling 50 to permit relative rotation therebetween. One such arrangement is shown in FIG. 5 and this embodiment will now be briefly discussed.

As with the previous embodiment, the hook coupling 50 is permanently connected to an opposite end of each one of the coupling arms 54. The lower most section of the hook coupling 50 defines a hook unit recess or aperture 66 and this hook unit recess or aperture 66 has an opening 68 which faces toward the hook unit 20. The hook unit recess or aperture 66 is sized and shaped to closely and intimately receive and accommodate the exterior surface of the male housing 28 of the hook unit 20, once the overall length of the dispensed wire cable 12 is gradually shortened and reeled onto the spool 14. The lower most portion of the hook unit recess or aperture 66 has a plurality of alignment features 72, e.g., notches, recesses, indentations, etc., which are located so as to engage with one or more mating alignment features 74, e.g., mating rods, projections, pins, etc., carried by the male housing 28 of the hook unit 20. Accordingly, as the male housing 28 of the hook unit 20 is pulled or drawn into the hook unit recess or aperture 66 of the hook coupling 50, by the spool 14 shortening the overall length of the dispense wire cable 12, the mating alignment features 72, 74 of the hook unit 20 and the hook coupling 50 eventually engage with one another. To assist with proper and non-interfering alignment of the alignment features 72 of the hook unit recess or aperture 66 are rounded or chamfered, e.g., or have some other conventional guiding and/or centering feature.

Once the male housing 28 is sufficiently received by the hook coupling 50, the engagement between the mating alignment features 72, 74 function so as to prevent any further relative rotation or spinning of the hook unit 20 relative to the hook coupling 50. However, when the male housing 28 is sufficiently spaced away from the hook coupling 50, e.g., the mating alignment features 72, 74 are spaced from one another, the hook unit 20 is able to spin or rotate relative to the hook coupling 50.

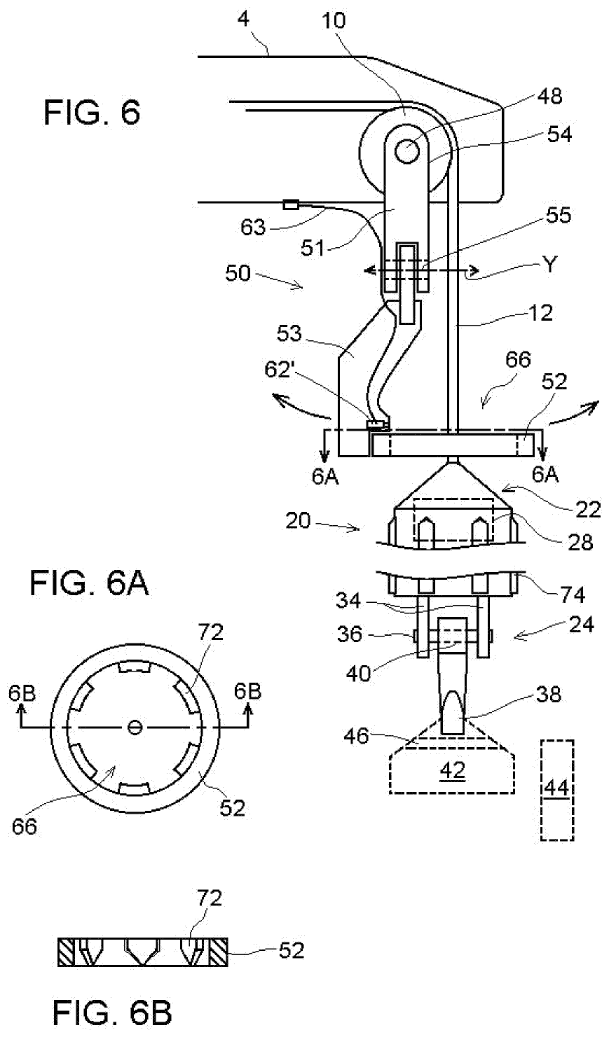

Turning now to FIGS. 6-8, a further embodiment of the present invention will now be described. As this embodiment is somewhat similar to the previously discussed embodiment, the differences between this new embodiment and the previous embodiments will be discussed in detail while identical elements will be given identical reference numerals.

As with the previous embodiments, the second free end of the wire cable 12 eventually terminates as an enlarged cylindrical head (not shown in detail). The hook unit 20 generally comprises the upper end 22 which is formed integrally with the lower end 24. This embodiment of the hook unit 20 typically does not include any circular ring or disc. The hook unit 20 typically has an axial length of between 6 inches and 48 inches, more preferably a length of between 12 inches and 36 inches or so.

The exterior surface of the upper end 22 of the hook unit 20 generally comprises a male housing 28 which defines an internal compartment (not shown in detail) which permanently receives and closely accommodates the enlarged cylindrical head while, at the same time, still permits rotation of the enlarged cylindrical head relative to the male housing 28 and a remainder of the hook unit 20. As a result of such arrangement, the hook unit 20 is permitted to rotate 360 degrees relative to the enlarged cylindrical head and the second end of the wire cable 12, in either rotational direction, during operation. To assist with such relative rotation, the internal compartment may be packed with or contain grease or some other lubricant for example (not shown in detail).

The lower end 24 of the hook unit 20 comprises a pair of spaced apart support members 34 which has a hook pin 36 extending therebetween. Each opposed end of the hook pin 36 is permanently secured to a respective one of the pair of spaced apart support members 34. An upper region of a conventional hook 38 is provided with a through bore 40 which extends completely through the upper region thereof. The hook pin 36 extends through the through bore 40 and thereby pivotally supports the hook 38 to the remainder of the hook unit 20. As a result of such arrangement, the hook 38 is capable of pivoting or swinging about the hook pin 36. It is to be appreciated that there are a number of alternative ways and techniques for attaching the hook 38 to the lower end 24 of the hook unit 20 which would be readily apparent to those skilled in the art and, as such, all such variations are considered to be included as part of this disclosure.

As with the previous embodiment, the hook 38 of the swivel hook assembly 2 is designed to support a desired suspended piece of equipment 42 (only diagrammatically shown), e.g., a self-powered mulcher, a self powered grappler, etc. The operator of the crane or jib 4 can control the amount of wire cable 12 dispensed by the spool 14 of the crane or jib 4 in order to raise, lower, position or reposition the desired piece of equipment 42, suspended by the hook 38, at a desired location relative to a desired object 44 (only diagrammatically shown).

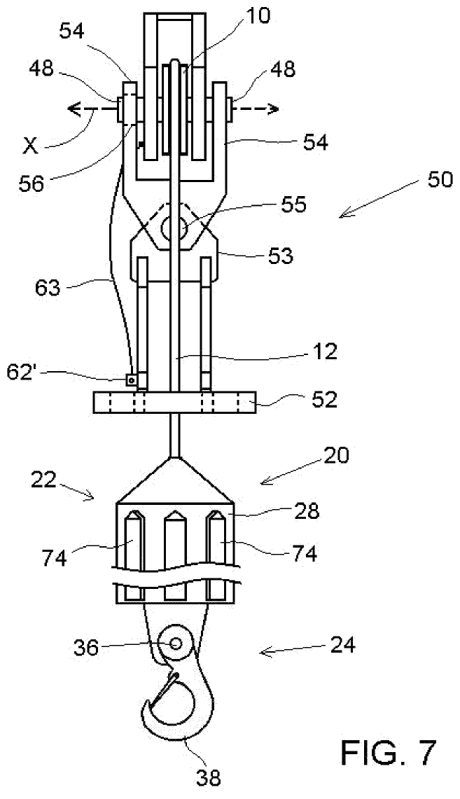

A pair of axially aligned pins 48 (as best shown in FIG. 7) are permanently secured to and extend outwardly away from and normal to the exterior surface of pair of plates 8 of the jib 4. The pair of axially aligned pins 48 together form a pivot axis X and a support for the swivel hook assembly 2. The pair of axially aligned pins 48 also prevent a hook coupling 50 from twisting or rotating relative to the jib 4. An upper end of the hook coupling 50 of the swivel hook assembly 2 has a pair of spaced apart coupling arms 54 which are spaced apart from one another by a distance slightly greater than the width of the jib 4, i.e., the spacing between the pair of spaced apart coupling arms 54 is slightly greater, e.g., a few inches or so, than the spacing between the outwardly facing surfaces of the two plates 8 of jib 4, as best shown in FIG. 7.

Each one of the coupling arms 54 has an opening 56′ formed therein. Each opening 56′ is sized and shaped so as to receive and closely accommodate a respective one of the axially aligned pins 48 therein, with a small amount of clearance or play. A surface of each opening 56′ is in direct contact or engagement with a mating surface of a respective one of the axially aligned pins 48 so that the hook coupling 50 normally can rock or pivot back and forth about the pivot axis X defined by the axially aligned pins 48, during operation of the swivel hook assembly 2. As a result of such arrangement, the hook coupling 50 is generally hung by the axially aligned pins 48 and is able to rock back and forth relative thereto in a plane, as shown by the double arrow in FIG. 6.

The upper section 51 of the hook coupling 50 is pivotably connected to the lower section 53 of the hook coupling 50 by a pivotal connection 55. This pivotable connection 55 is oriented 90 degrees with respect to the pivotable connection between the hook coupling 50 and the axially aligned pins 48. As a result of such pivotable connection 55, the lower section 53 of the hook coupling 50 is able to pivot or rock back and forth about pivot axis Y, with respect to the upper section 51 of the hook coupling 50 in a plane which is normal to the plane that hook coupling 50 is able to rock back and forth relative to the axially aligned pins 48. Both of those pivotable connections provide the hook coupling 50 with desired flexibility.

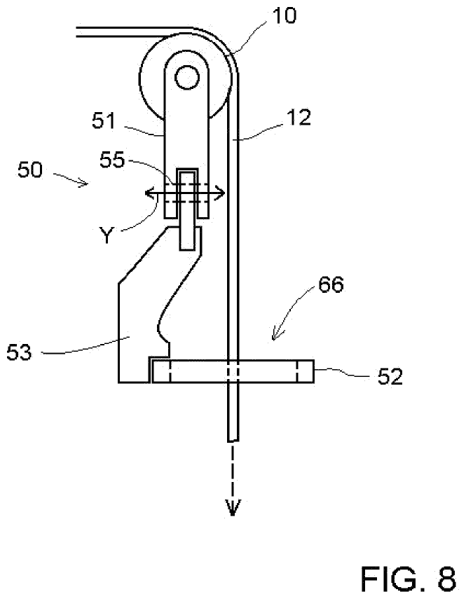

As shown in FIGS. 6 and 8, the lower section 53 of the hook coupling 50 is generally C-shaped and comprises a hook housing 52. As shown in FIG. 7, the lower section 53 of the hook coupling 50 may comprise a pair of spaced apart plates which have a similar or identical C-shape and together support the hook housing 52. The hook housing 52 defines a hook unit recess or aperture 66 and this hook unit recess or aperture 66 has an inlet opening 68 which faces toward the hook unit 20, e.g., the inlet opening 68 is a throughbore. The C-shape of the lower section 53 of the hook coupling 50 is designed as a counterweight for the hook housing 52 which helps stabilize and balance the same so that the hook housing 52 typically remains in a generally horizontal orientation, i.e., generally parallel to the ground, during use, as generally shown. That is, the wire cable 12 typically remains center with respect to the throughbore extending through the hook housing 52. The hook unit recess or aperture 66 is sized and shaped so as to closely and intimately receive and accommodate the exterior surface of the male housing 28 of the hook unit 20, once the overall length of the dispensed wire cable 12 is sufficiently shortened and reeled onto the spool 14 so as to drawn the hook unit 20 into engagement with the hook housing 52.

The hook unit recess or aperture 66 is sized and shaped to closely and intimately receive and accommodate the exterior surface of the male housing 28 of the hook unit 20, once the overall length of the dispensed wire cable 12 is sufficiently shortened and reeled onto the spool 14. To assist with alignment and reception of the hook unit 20 within the hook unit recess or aperture 66, a leading surface of the upper end 22 of the hook unit 20 is tapered toward the dispensed wire cable 12 from the cylindrical male housing 28, e.g., the leading surface of the upper end 22 of the hook unit 20 is conical and forms a centering feature as diagrammatically shown in FIGS. 6-7. According to this embodiment, the hook unit recess or aperture 66 is not provided with any stop surface which prevents or inhibits further passage or insertion of the male housing 28 of the hook unit 20 into or through the hook unit recess or aperture 66.

The radially inwardly facing surface of the hook unit recess or aperture 66 is typically provided with one or more alignment features 72, e.g., projections, indentations, ribs, grooves, slots, channels, rails, recesses, etc., which are located so as to engage with one or more mating alignment features 74, e.g., mating projections, indentations, ribs, grooves, slots, channels, rails, recesses, etc., carried by the exterior surface of the male housing 28 of the hook unit 20. Accordingly, as the male housing 28 of the hook unit 20 is pulled or drawn into the hook unit recess or aperture 66 of the hook coupling 50, by the spool 14 shortening the overall length of the dispense wire cable 12, the mating alignment features 72, 74 of the hook unit 20 and the hook coupling 50 eventually engage with one another. To assist with proper and non-interfering alignment of the mating alignment features 72 of the hook unit recess or aperture 66 with the alignment features 74 of the male housing 28, the leading ends of one, or both of, the mating alignment features 72, 74 may be pointed, rounded or chamfered, or have some other conventional guiding and/or centering feature (only diagrammatically shown in FIGS. 6-7).

A proximity sensor 62′, or some other conventional sensor, device or mechanism, is supported by the lower section 53 of the hook coupling 50, adjacent a trailing end of the hook unit recess or aperture 66, for detecting the presence of the male housing 28 of the hook unit 20, once the male housing 28 is sufficiently received within the hook unit recess or aperture 66. The proximity sensor 62′ may be electrically connected with the motor or drive for the spool 14, via electrical line 63 to interrupt further reeling in of the wire cable 16 by the spool 14 as soon as the proximity sensor 62′ is activated. That is, when the proximity sensor 62′ detects that the male housing 28 of the hook unit 20 is sufficiently received by the hook unit recess or aperture 66, i.e., the mating alignment features 72, 74 are sufficiently engaged with one another so as to prevent relative rotation therebetween, then the proximity sensor 62′ transmits a signal or an alarm to a receiver (not shown), associated with motor or drive for the spool 14 (or possibly sends a signal to the operator), which can be designed to automatically discontinue reeling in of any additional wire cable 12 by the spool 14 and thereby prevent damage from occurring to the swivel hook assembly 2 or the crane or jib 4. Following activation of the proximity sensor 62′, the spool 14 may possibly be activated (either automatically or by the operator) to dispense a small amount of the wire cable 12, e.g., 2-14 inches or so, so as to lower the swivel hook assembly 2 a small distance while still ensuring that the mating alignment features 72, 74 remain sufficiently engaged with one another received within the hook unit recess or aperture 66 so as to prevent relative rotation therebetween.

As the male housing 28 of the hook unit 20 is pulled or drawn into the hook unit recess or aperture 66 of the hook coupling 50, by the spool 14 shortening the overall length of the dispense wire cable 12, the mating alignment features 72, 74 of the hook unit 20 and the hook coupling 50 eventually engage with one another. To assist with proper and non-interfering alignment of the alignment features 74 of the male housing 28 with the mating alignment features 72 of the hook unit recess or aperture 66, the leading ends of one, or both of, the mating alignment features may be pointed, rounded or chamfered, or have some other conventional guiding and/or centering feature (not shown in detail).

Once the male housing 28 is sufficiently received by and engaged with the hook coupling 50, the engagement between the mating alignment features 72, 74 function so as to prevent any further relative rotation or spinning of the hook unit 20 relative to the hook coupling 50. As noted above, the hook coupling 50 is mounted to the jib 4 so as to prevent any rotation of the hook coupling 50 and, due to such engagement, now the hook unit 20 is prevented from rotating relative to the jib 4. As such, when the male housing 28 is sufficiently received within the hook coupling 50, such engagement prevents any relative rotation therebetween and assists the jib 4 with more precisely controlling and/or maneuvering of the suspended piece of equipment 42 relative to a desired object 44, e.g., a section or portion of a tree or a trunk, a desired limb or branch, etc.

Once the male housing 28 is fully seated within the hook coupling 50, any further shortening of the overall length of the dispensed wire cable 12, by the spool 14, will cause the enlarged cylindrical head 18 to pull and draw the male housing 28, but not the hook coupling 50 according to this embodiment, upwardly toward the final pulley 10 supported by the jib 4. As noted above, the proximity sensor 62′ detects the present of the hook unit 20 well before the hook unit 20 commences engagement with the final pulley 10. The proximity sensor 62′ sends a signal and/or sounds an alarm designed to prevent or minimize further reeling in or shortening of the dispensed length of the wire cable 12, by the spool 14, and thereby to prevent any damage from occurring to the swivel hook assembly 2 or the jib 4.

Once the proximity sensor 62′ is activated, typically either the spool 14 will immediately discontinue rotation or the operator will actuate the spool 14 to discontinue operation thereof and possibly reverse the direction of the spool 14 so as to the feed out a small amount of additional wire cable 12, e.g., a 2-12 inches or so, while still ensuring that the male housing 28 remains sufficiently engaged with the hook coupling 50 so that the proximity sensor 62′ can still detect such engagement.

As with the previous embodiments, the swivel hook assembly 2 generally has two separate and distinct operative positions. The first disengaged operative position is when the male housing 28 is sufficiently spaced away from the hook coupling 50 so that none of the mating alignment features 72, 74 are in engagement with one another (see FIG. 6 for example). In this disengaged operating position, the hook unit 20 is freely rotatable with respect to the hook coupling 50 and can be raised or lowered by the operator, as necessary or required, to manipulate the suspended piece of equipment 42 into a desired position and achieve a desired operating function of the suspended piece of equipment 42, e.g., chipping of a desired limb(s), branch(es), tree, trunk, cut off a desired limb(s) or branch(es), cut of a desired section of a tree or a trunk, etc.

In the second engaged operating position, the male housing 28 is sufficiently received within the hook unit recess or aperture 66 of the hook coupling 50 by the spool 14 shortening the overall length of the dispense wire cable 12. As this occurs, the mating alignment features 72, 74 of the male housing 28 and the hook unit recess or aperture 66 are brought into engagement with one another, by the spool 14 shortening the overall length of the dispense wire cable 12, so as to prevent any relative rotation of the hook unit 20 relative to the jib 4.

It is to be appreciated that there are a variety of other arrangements, techniques, designs, etc., which would be apparent to those skilled in the art for selectively locking or coupling the hook unit 20 to the hook coupling 50 and preventing relative rotation therebetween or sufficiently spacing the male housing 28 away from the hook coupling 50 so that the hook unit 20 is able to spin or rotate relative to the hook coupling 50. It is to be appreciated that all such other arrangements, techniques, designs, etc., would be readily apparent to those skilled in the art are considered to be part of the disclosure of this application.

While various embodiments of the present invention have been described in detail, it is apparent that various other modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

Although operations are depicted in the drawings in a particular order, this should not be understood as requiring that such operations be performed in the particular order shown or in sequential order, or that all illustrated operations be performed, to achieve desirable results.

Wherefore, I/we claim:

1. A swivel hook assembly comprising:
a hook unit supporting a hook which facilitates suspending a desire piece of equipment from the swivel hook assembly, and the hook unit being engageable with a free end of a wire cable which controls at least vertical movement of the hook unit; and
a hook coupling having an upper end for engagement with a jib and a second end for engaging with the hook unit so that, when the hook unit is moved by the wire cable into engagement with the hook coupling, relative rotation between the hook unit and the hook coupling is prevented while, when the hook unit is spaced away and disengaged from the hook coupling, relative rotation between the hook unit and the hook coupling is permitted.

2. The swivel hook assembly according to claim 1, wherein the hook unit comprises an upper section which is formed integrally with a lower section, and the lower section supports the hook.

3. The swivel hook assembly according to claim 2, wherein a surface of the hook coupling has one or more alignment features while a surface of the hook unit has one or more mating alignment features and, when the alignment features of the hook unit and the hook coupling mate with one another, the mating alignment features prevent relative rotation between the hook unit and the hook coupling.

4. The swivel hook assembly according to claim 3, wherein a leading end of the alignment features of at least one of the hook coupling and the hook unit is one of pointed, rounded or chamfered, to assist with alignment and engagement of the mating alignment features with one another.

5. The swivel hook assembly according to claim 2, wherein the upper section of the hook unit comprises a male housing and an interior of the male housing defines an internal compartment which receives and accommodates a head secured to a free end of the wire cable so as to couple the wire cable to the kook unit while still permitting rotation of the hook unit relative to the head.

6. The swivel hook assembly according to claim 5, wherein the interior compartment of the male housing contains a lubricant which minimizes friction which is generated during relative movement between the hook unit and the head.

7. The swivel hook assembly according to claim 2, wherein the hook is pivotably attached to the hook unit so that the hook is capable of pivoting or swinging relative to a remainder of the hook unit.

8. The swivel hook assembly according to claim 1, wherein the upper end of the hook coupling has a pair of spaced apart coupling arms which are spaced apart from one another by a distance slightly greater than a width of the jib, and each one of the coupling arms has an opening formed therein which receives a respective pin secured to the jib so as to permit the hook coupling to rock or pivot back and forth about a pivot axis defined by the respective pins.

9. The swivel hook assembly according to claim 1, wherein the upper section of the hook coupling is pivotably connected to a lower section of the hook coupling, and the pivotable connection of the upper section to the lower section is oriented 90 degrees with respect to the pivotable connection between the hook coupling and the pins.

10. The swivel hook assembly according to claim 9, wherein the lower section of the hook coupling is generally C-shaped and comprises a hook housing, and the C-shape of the lower section of the hook coupling forms a counterweight for the hook housing which helps maintain the hook housing in a substantially horizontal orientation during use.

11. The swivel hook assembly according to claim 9, wherein the lower section of the hook coupling supports a hook unit recess or aperture, the hook unit recess or aperture faces toward the hook unit, and the hook unit recess or aperture is shaped to receive the male housing of the hook unit, once the hook unit is sufficiently drawn into the hook unit recess or aperture by the wire cable.

12. The swivel hook assembly according to claim 11, wherein a sensor is located adjacent the hook unit recess or aperture for detecting when the hook unit is sufficiently received by the hook unit recess or aperture so as to prevent relative rotation therebetween.

13. The swivel hook assembly according to claim 12, wherein the hook unit recess or aperture comprises a throughbore.

14. The swivel hook assembly according to claim 1, wherein a fixed end of the wire cable is connected to a rotatable spool, supported by a base of the jib, and when the spool is rotated in a first rotational direction, the spool feeds out an additional amount of the wire cable so as to increase an overall length of the dispensed wire cable, and, when the spool is rotated in an opposite second rotational direction, the spool gradually reels in a portion of the wire cable so as to decrease the overall length of the dispensed wire cable.

15. The swivel hook assembly according to claim 1, wherein a lower end of the hook housing comprises a pair of spaced apart plates which has a hook pin extending therebetween, and an upper region of the hook is provided with a through bore which extends completely through the upper region of the hook so that the hook is capable of pivoting or swinging about the hook pin.

16. The swivel hook assembly according to claim 1, wherein the desired suspended piece of equipment is one of a self-powered mulcher and a self powered grappler.

17. The swivel hook assembly according to claim 1, wherein a non-electrically conductive sling couples the hook, of the swivel hook assembly, to the desired suspended piece of equipment.

18. The swivel hook assembly according to claim 1, wherein an upper portion of the desired suspended piece of equipment is equipped with a hydraulic rotator which couples the desired suspended piece of equipment to the hook of the swivel hook assembly and assists an operator with rotating or steer of the desired suspended piece of equipment, relative to the swivel hook assembly and a desired object.

19. A method of suspending a desire piece of equipment from a swivel hook assembly, the method comprising:
supporting a hook, via a hook unit, which facilitates suspending the desire piece of equipment from the swivel hook assembly;
engaging the hook unit with a free end of a wire cable which controls at least vertical movement of the hook unit; and
providing a hook coupling having an upper end for engagement with a jib and a second end for engaging with the hook unit such that when the hook unit is moved, by the wire cable, into engagement with the hook coupling relative rotation, between the hook unit and the hook coupling, is prevented but, when the hook unit is spaced away and disengaged from the hook coupling, relative rotation between the hook unit and the hook coupling is permitted.
